(19) United States
(12) Patent Application Publication
(10) Pub. No.: US 2001/0049735 A1
(43) Pub. Date: Dec. 6, 2001

(54) Calculation service providing system

(76) Inventors: Eiichi Nakano, Tokyo (JP); Hitoshi Nonomura, Tokyo (JP)

Correspondence Address: McGinn & Gibb, PLLC, Suite 200, 8321 Old Courthouse Road, Vienna, VA, 22182-3817, US

(21) Appl. No.: 09/864,301

(22) Filed: May 25, 2001

(30) Foreign Application Priority Data
May 29, 2000 (JP) 2000-159023

(51) Int. Cl. G06F 15/16; G06F 15/173

(52) U.S. Cl. 709/225; 709/218

(57) ABSTRACT

A calculation service providing system, comprising calculation servers, a Web server and terminals which are connected to one another on a network, wherein each of the calculation servers stores one or more applications for providing calculation service, wherein the Web server stores and publishes on the network one or more procedure data files, in each of which procedure data defining a calculation service using the one or more applications stored in one or more of the calculation servers is described, and wherein each of the terminals executes a procedure processing program for having one or more of the calculation servers execute one or more applications on the basis of the procedure data described in the procedure data file downloaded from the Web server.

### BACKGROUND OF THE INVENTION

1. Field of the Invention

The present invention relates to a calculation service providing system for providing to a user calculation services present on a network in a distributed fashion.

2. Description of Prior Art

As an example of a conventional calculation service providing system, there is a system consisting of a Web client operating on a user terminal, a service linkage server and a service providing server The conventional calculation service providing system thus constituted operates as follows. The Web client issues a service request to the service linkage server. The service linkage server issues a request to the service providing server. The service providing server carries out a processing.

The conventional technique stated above has, however, the following disadvantages. The above system is unable to access an arbitrary service which becomes available to a user by logging in a remote machine by way of a telnet which is the most fundamental method for the user to normally utilize a calculation service, for the following reason. According to the above-stated system, if a request is issued to the calculation server, it is necessary that the service linkage server mediates between the Web server and the calculation server and the Web client on the user's terminal is not, therefore, directly connected to the calculation server through the telnet.

Further, the above system is inferior in expandability and flexibility. Namely, an application which the user used personally before introducing the system cannot be used on the system, for the following reason. Normally, for the user to utilize an application in the calculation server, the Web client of the user accesses the application from the user's terminal through the telnet. The above-stated system is required to access the calculation server by way of the service linkage server. Due to this, the user is required to ask the administrator of a server, which the user wants to access, to register the user. However, if the service is not widely available to other users, it is not easy to register the user with a common server.

Moreover, according to the above-stated system, it is impossible to easily open a service defined by a user oneself by utilizing an arbitrary Web server managed by the user, for the following reason. According to the system, since the service linkage server controls the service providing server, only the administrator of the service linkage server can register a new service.

Further, the above-sated system is lacking in a function of dynamically selecting an application to be executed according to the load of a machine. This is because service execution procedures are fixed in the system and the system has no function for dynamically changing the execution procedures.

The present invention has been made to solve the above-stated disadvantages. It is, therefore, an object of the present invention to make it possible to simplify processings performed repeatedly in procedures for utilizing from a user's terminal various calculation services provided by computers connected to a network, such as the Internet, thereby allowing the user to easily utilize the calculation services.

### SUMMARY OF THE INVENTION

According to the present invention, there is provided a calculation service providing system, comprising calculation servers, a Web server and terminals which are connected to one another on a network, wherein each of said calculation servers stores one or more applications for providing calculation service, wherein said Web server stores and publishes on said network one or more procedure data files, in each of which procedure data defining a calculation service using said one or more applications stored in one or more of said calculation servers is described, and wherein each of said terminals executes a procedure processing program for having one or more of said calculation servers execute one or more applications on the basis of said procedure data described in said procedure data file downloaded from said Web server.

In the calculation service providing system, each of said terminals may access one or more said calculation servers with telnet protocol and ftp protocol when having the calculation servers execute one or more applications and transfer one or more files, respectively.

In the calculation service providing system, each of said terminals may execute a procedure data creation program for creating each of said procedure data files.

In the calculation service providing system, said Web server may store a procedure data optimization program for dynamically rewriting each of said procedure data files on the basis of loads on respective calculation servers so that the rewritten procedure data file is described with an optimum calculation server for executing each application among calculation servers executable the application.

In the calculation service providing system, a Web browser may be installed on each of said terminals, and said procedure processing program may be downloaded from said Web server to each of said terminal and executed on said Web browser.

In the calculation service providing system, a Web browser may be installed on each of said terminal, and said procedure data creation program may be downloaded from said Web server to each of said terminal and executed on said Web browser.

### BRIEF DESCRIPTION OF THE DRAWINGS

FIG. 1 is a block diagram showing a first embodiment of a calculation service providing system according to the present invention;

FIG. 2 is a view showing the details of a procedure data display program 2-1 and a procedure processing program 2-2 downloaded to a Web browser 5-1; and

FIG. 3 is a block diagram showing a second embodiment of a calculation service providing system according to the present invention.

### DESCRIPTION OF THE EMBODIMENTS OF THE INVENTION

According to the present invention, procedures to utilizing various types of calculation services provided by computers connected to the Internet from a user's terminal are stored as procedure data in order to easily perform repetitive processings. In addition, the file of the procedure data is published on a Web server in order to make it possible to easily utilize calculation services from terminals accessible to the Web server and computers (or calculation servers) which provide the calculation services.

A procedure data display program 2-1 and a procedure processing program 2-2 included in a Web server 2 are downloaded to users' terminals 5 and 6 each mounting thereon a Web browser 5-1 and the procedure data display program 2-1 and the procedure processing program 2-2 are executed on the Web browsers 5-1. Thereafter, the procedure data display program 2-1 and the procedure processing program 2-2 obtain a procedure data file 1-1 from a Web server 1 and perform the procedures described in the procedure processing program 2-2.

These procedures include a procedure of automatically logging in various calculation servers 3 and 4, a procedure of executing commands, and a procedure of starting arbitrary programs. A procedure data creation program 2-3 included in the Web server 2 is a program for creating the procedure data file 1-1 and other procedure data files and allows a user to form routine procedures into a procedure data file by a simple operation. The procedure data file thus created is registered with and published on an arbitrary Web server, thereby making it possible for the procedure data file to be shared among a plurality of users.

This system also has a function of dynamically changing “information determining a machine to be used” in the procedure data file in consideration of information on loads of respective calculation servers and available computer resources if an application described in the procedure data file is executable on a plurality of calculation servers. This function enables a user who selects a use of a certain application on the user's terminal to automatically utilize the most efficiently available calculation server among calculation servers performable the application.

As an example of using this system, a procedure data file for inputting a file /aa/bb/cc in a calculation server 3, for executing a calculation program /dd/ee/ff in a calculation server 4, and for storing an output in a file /dd/ee/gg, is created, and registered with and published on the Web server 1.

The programs 2-1 and 2-2 operating on a terminal 5 connected to the Web server 1 acquire this procedure data file, interprets the acquired procedure data file and automatically executes the following processings. First, the program logs in the calculation server 3. Next, the program executes a command to transfer the data file /aa/bb/cc in the calculation server 3 to a temporary region in the calculation server 4 and logs in the calculation server 4. The program /dd/ee/ff is executed in the calculation server 4 with the already transferred data file /aa/bb/cc used as an input file.

At this time, if the same program as the program /dd/ee/ff on the calculation server 4 exists in another calculation server 7 which is more efficiently available, the procedure data file is automatically rewritten so as to use the calculation server 7.

In this way, by utilizing the system incorporating the above-stated mechanism, the user can convert procedures for utilizing an arbitrary calculation service into a procedure data file, use the procedures in the procedure data file with a simple operation, and register the procedure data file with a Web server so as to allow other users to easily use the procedure data file from other terminals and to execute the procedures in the procedure data file.

Furthermore, by providing all the services on calculation servers through Web servers while using this mechanism, it is possible to provide a working environment for using these calculation servers and to share the working environment among many users.

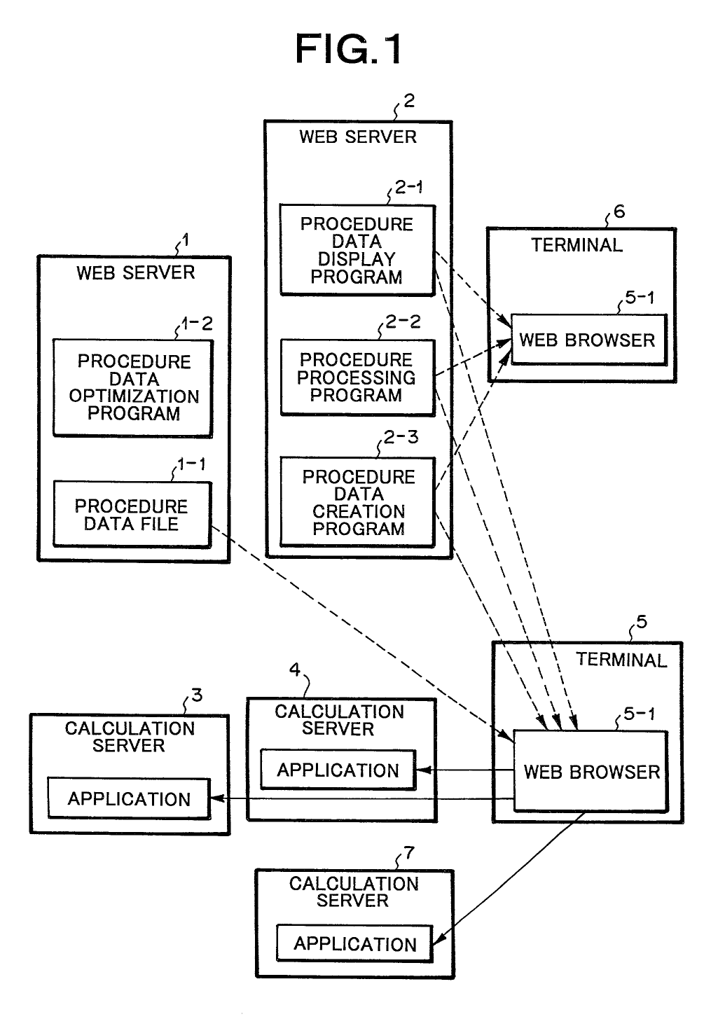

Next, the constitution of the first embodiment of the calculation service providing system according to the present invention will be described with reference to FIG. 1. In this embodiment, the calculation service providing system comprises a Web server 1 for publishing procedure data files, a Web server 2 for storing applets to be operated on a Web browser on each terminal, calculation servers 3, 4 and 7 for providing calculation services and terminals 5 and 6 The Web server 1 and the Web server 2 may be unified.

A procedure data file 1-1 is stored in the Web server 1. A procedure data display program 2-1, a procedure processing program 2-2 and a procedure data creation program 2-3 which will be downloaded to Web browsers on the respective terminals and operate thereon are stored in the Web server 2. On each of the terminals 5 and 6, the Web browser 5-1 operates. The programs on the Web server 2 are downloaded to and then executed on the Web browser 5-1.

Next, the outline of the operation of this embodiment will be described. First, when the terminal 5 accesses the Web server 2, the procedure data display program 2-1 is downloaded to and executed on the Web browser 5-1 operating on the terminal 5. The procedure data display program 2-1 reads the procedure data file 1-1 stored in the Web server 1 and displays icons which a user can recognize on the display of the terminal. These icons correspond to procedures for accessing calculation servers and executing calculations.

When the user selects an icon by operating a mouse or the like while using the procedure data display program and issues an execution instruction, the procedure processing program 2-2 corresponding to the icon is automatically selected, downloaded to the terminal 5 and executed on the Web browser 5-1. The procedure processing program 2-2 acquires data on processing procedures for accessing a calculation server from the data display program 2-1, accesses the calculation server using communication processing means and performs a calculation processing.

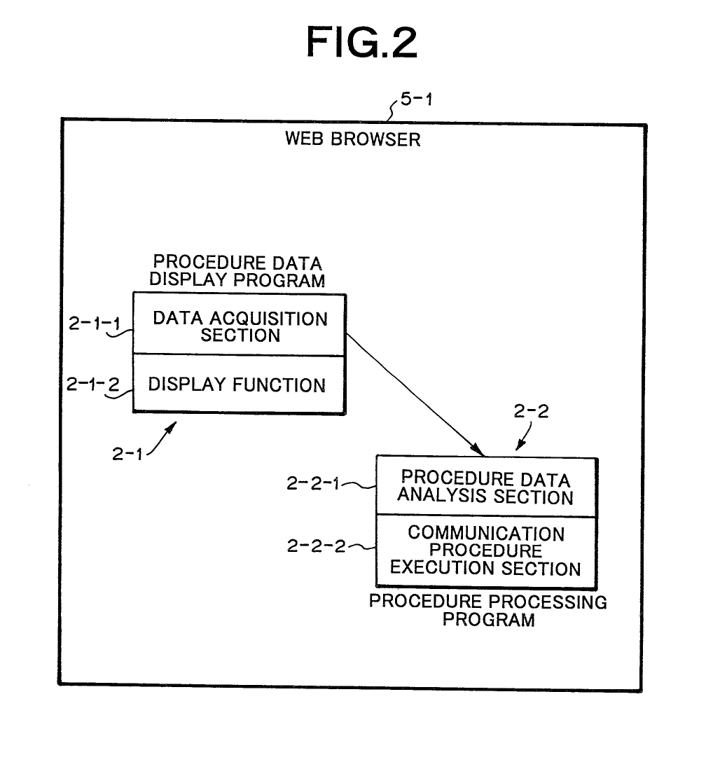

FIG. 2 shows the details of the procedure data display program 2-1 and the procedure processing program 2-2 which have been downloaded to the Web browser 5-1. The procedure data display program 2-1 includes a data acquisition section 2-1-1 and a display function 2-1-2. The procedure processing program 2-2 includes a procedure data analysis section 2-2-1 and a communication procedure execution section 2-2-2 for automatically logging in a remote machine through the telnet and issuing an arbitrary instruction.

Referring back to FIG. 1, the procedure data file 1-1 published on the Web server 1 is substantially a file containing procedures for accessing remote machines and using calculation services. This file is registered with the Web server 1. This file can also be created by using the procedure data creation program 2-3. If there are a plurality of calculation servers which can execute a procedure described in the procedure data file, a procedure data optimization program 1-2 performs processings for judging which calculation server shall be used in view of the loads of the respective calculation servers and for dynamically rewriting the procedure data file.

The calculation servers 3, 4 and 7 which provide calculation services are computers of which services become available by logging in the calculation servers through the telnet. The services which the calculation servers 3, 4 and 7 can provide are all the services that become available by logging in the calculation servers through the telnet.

Simple operations on GUI have procedure data creation program 2-3 to create a procedure data file for accessing an arbitrary service provided by an arbitrary machine which is currently accessible through the telnet. The Web server 1 publishes the procedure data file created by the program 2-3, whereby the procedure data file can be interpreted and executed by all the terminals mounting thereon the Web browsers accessing the Web server 1.

Next, the detailed operation of this embodiment will be described. First, the terminal 5 mounting thereon the Web browser 5-1 accesses the Web server 2 Then, the procedure data display program 2-1 and the procedure processing program 2-2 are automatically downloaded to the terminal 5 and executed on the Web browser 5-1.

When the procedure data display program 2-1 is executed on the Web browser 5-1, the procedure data file 1-1 is read from the Web server 1 to the Web browser 5-1 and various icons indicating calculation services, respectively, are displayed on the display of the terminal 5. The user can select and execute any icon by operating a mouse or the like.

When a program execution instruction is issued by the operation of the icon, the procedure data in the procedure data file is supplied to the procedure processing program 2-2. The procedure data is analyzed by the procedure data analysis section 2-2-1 of the procedure processing program 2-2 and executed by the communication procedure execution section 2-2-2 thereof. If there are a plurality of calculation servers which can execute a procedure described in the procedure data file 1-1, the procedure data optimization program 1-2 performs processings for judging which calculation server shall be used in view of the loads of the respective calculation servers and for dynamically rewriting the procedure data file. The communication procedure execution section 2-2-2 accesses the calculation servers 3,4 and 7 in accordance with either a telnet protocol or an ftp protocol and have an application be executed.

Next, the operation of this embodiment will be described using an example A processing A for transferring a file /aa/bb/cc stored in the calculation server 3 to the calculation server 4 and for having the calculation server 4 execute the application /aaa/bbb of calculation with the file /aa/bb/cc used as an input file, will be exemplified.

First, the terminal 5 mounting the Web server 5-1 thereon accesses the Web server 2 by designating the URL of the Web server 2, and then, some icons are displayed on the display of the terminal 5 by the procedure data display program 2-1. One of the displayed icons corresponds to the processing A.

The icon corresponding to the processing A is selected and an execution instruction is issued, and then, information on the processing A is supplied to the procedure processing program 2-2 and is executed by the communication procedure execution section 2-2-2 of the procedure processing program 2-2. The communication procedure execution section 2-2-2 logs in the calculation server 3 in accordance with the telnet protocol. Next, the communication procedure execution section 2-2-2 executes an ftp command on the calculation server 3, thereby transferring the file /aa/bb/cc to the calculation server 4. Next, the communication procedure execution section 2-2-2 logs in the calculation server 4 and have the calculation server execute an application /aaa/bbb with the transferred file /aa/bb/cc used as an input file.

Another example of executing solver on a calculation server with a file on a terminal used as a data file will be described. A processing B for transferring the file /aa/bb/cc stored in the terminal 5 to the calculation server 4 and for having the calculation server 4 execute the application /aaa/bbb with the file /aa/bb/cc used as an input file, will be exemplified.

When an icon corresponding to the processing B is selected and an execution instruction is issued, information on the processing B is supplied to the procedure processing program 2-2 and is executed by the communication procedure execution section 2-2-2 included in the procedure processing program 2-2. The communication procedure execution section 2-2-2 is connected to the calculation server 4 according to the ftp protocol, transfers the file /aa/bb/cc to the calculation server 4, logs in the calculation server 4 and have the calculation server executes the application /aaa/bbb with the transferred file /aa/bb/cc used as an input file.

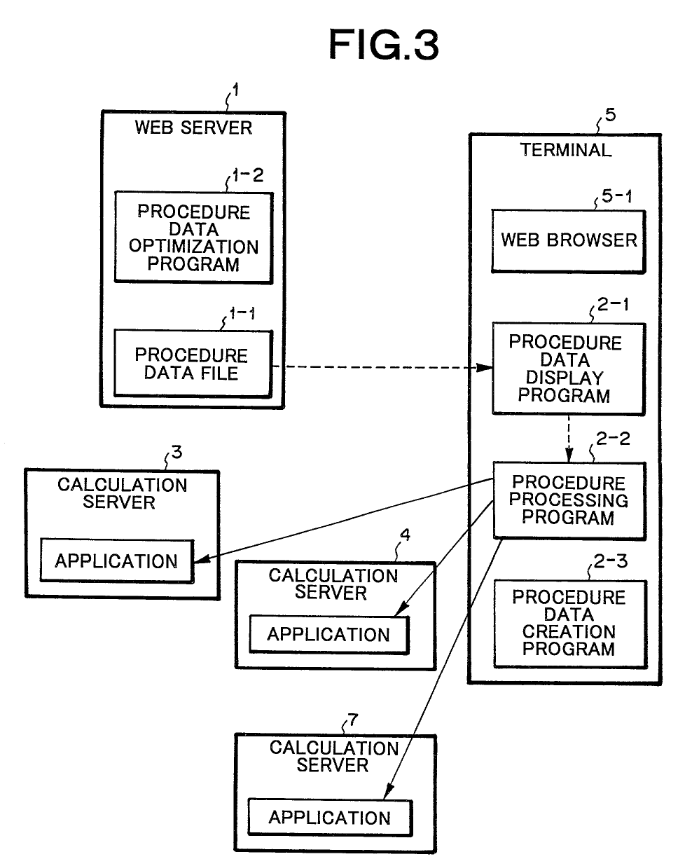

Next, the second embodiment of the present invention will be described with reference to FIG. 3. The second embodiment differs from the first embodiment shown in FIG. 1 in that a procedure data display program 2-1, a procedure processing program 2-2 and a procedure data creation program 2-3 are not stored in a Web server but installed on a terminal 5 in advance. In the case of the second embodiment, these programs may be executed on a Web browser 5-1 or may be executed without the Web browser 5-1.

Next, the overall operation of this embodiment will be described. It is assumed that a user utilizes the terminal 5 on which the three programs are installed. When the procedure data display program 2-1 is executed, the procedure data file 1-1 is read from the Web server 1 to the terminal 5 and various icons indicating calculation services are displayed on the display of the terminal 5. The user selects one of the icons by operating a mouse or the like to make it possible to execute the calculation corresponding to the selected icon.

When an execution instruction is issued by the operation of the icon, procedure data in the procedure data file is supplied to the procedure processing program 2-2, analyzed by the procedure data analysis section 2-2-1 of the procedure processing program 2-2 and executed by the communication procedure execution section 2-2-2 thereof If there are a plurality of calculation servers which can execute a procedure described in the procedure data file 1-1, a procedure data optimization program 1-2 performs processings for judging which calculation server shall be used in view of load information on the respective calculation servers, applicable computer resources and the like and for dynamically rewriting the procedure data file. The communication procedure execution section 2-2-2 accesses calculation servers 3, 4 and 7 in accordance with either a telnet protocol or an ftp protocol and have the servers execute applications.

Next, the operation of this embodiment will be described using an example. A processing C for transferring a file /aa/bb/cc stored in the calculation server 3 to the calculation server 4 and for having the calculation server 4 execute an application /aaa/bbb of calculation, will be exemplified. First, when the procedure data display program 2-1 is executed on the terminal 5, some icons indicating some procedures are displayed on the display of the terminal 5, wherein one of the icons is an icon indicating the processing C.

When the icon corresponding to the processing C is selected and an execution instruction is issued, information on the processing C is supplied to the procedure processing program 2-2 and executed by the communication procedure execution section 2-2-2 included in the procedure processing program 2-2. The communication procedure execution section 2-2-2 logs in the calculation server 3 in accordance with the telnet protocol. The communication procedure execution section 2-2-2 then executes an ftp command on the calculation server 3, thereby transferring the file /aa/bb/cc to the calculation server 4. Next, the communication procedure execution section 2-2-2 logs in the calculation server 4 and have the calculation server 4 execute an application /aaa/bbb with the transferred file /aa/bb/cc used as an input file.

According to the present invention, the Web server publishes procedure data files, in each of which procedures for using calculation servers are described, on the network such as the Internet, so that a common calculation service execution environment can be provided to a plurality of users. In addition, the users need not be aware which server provide calculation respective service and which application provide respective service.

Moreover, if the procedure data creation program for creating a procedure data file is stored in a terminal, procedure data reflecting a series of operations can be easily created. Storing the procedure data thus created as a procedure data file enables an automatic execution of the series of operations a number of times, whereby it is possible to easily execute a series of complex operations required to be executed a number of times.

Furthermore, because the procedure data optimization program automatically rewrites the procedure data file to select the optimum calculation server in view of the loads of calculation servers which provide each calculation service, users can utilize the optimum calculation server which efficiently provides the calculation service.

What is claimed is:

1. A calculation service providing system, comprising calculation servers, a Web server and terminals which are connected to one another on a network,
wherein each of said calculation servers stores one or more applications for providing calculation service,
wherein said Web server stores and publishes on said network one or more procedure data files, in each of which procedure data defining a calculation service using said one or more applications stored in one or more of said calculation servers is described, and
wherein each of said terminals executes a procedure processing program for having one or more of said calculation servers execute one or more applications on the basis of said procedure data described in said procedure data file downloaded from said Web server.

2. The calculation service providing system as set forth in claim 1,
wherein each of said terminals accesses one or more said calculation servers with telnet protocol and ftp protocol when having the calculation servers execute one or more applications and transfer one or more files, respectively.

3. The calculation service providing system as set forth in claim 1,
wherein each of said terminals executes a procedure data creation program for creating each of said procedure data files.

4. The calculation service providing system as set forth in claim 1,
wherein said Web server stores a procedure data optimization program for dynamically rewriting each of said procedure data files on the basis of loads on respective calculation servers so that the rewritten procedure data file is described with an optimum calculation server for executing each application among calculation servers executable the application.

5. The calculation service providing system as set forth in claim 1,
wherein a Web browser is installed on each of said terminals, and
wherein said procedure processing program is downloaded from said Web server to each of said terminal and executed on said Web browser.

6. The calculation service providing system as set forth in claim 3,
wherein a Web browser is installed on each of said terminal, and
wherein said procedure data creation program is downloaded from said Web server to each of said terminal and executed on said Web browser.

7. A calculation service providing method, for a system comprising calculation servers, a Web server and terminals which are connected to one another on a network, said method comprising steps of:
causing each of said calculation servers to store one or more applications for providing calculation service;
causing said Web server to store and publish on said network one or more procedure data files, in each of which procedure data defining a calculation service using said one or more applications stored in one or more of said calculation servers is described; and
causing each of said terminals execute a procedure processing program for having one or more of said calculation servers execute one or more applications on the basis of said procedure data described in said procedure data file downloaded from said Web server.

8. The calculation service providing method as set forth in claim 7, further comprising:
a step of causing each of said terminals access one or more said calculation servers with telnet protocol and ftp protocol when having the calculation servers execute one or more applications and transfer one or more files, respectively.

9. The calculation service providing method as set forth in claim 7, further comprising:
a step of causing each of said terminals execute a procedure data creation program for creating each of said procedure data files.

10. The calculation service providing method as set forth in claim 7, further comprising:
a step of causing said Web server store a procedure data optimization program for dynamically rewriting each of said procedure data files on the basis of loads on respective calculation servers so that the rewritten procedure data file is described with an optimum calculation server for executing each application among calculation servers executable the application.

11. The calculation service providing method as set forth in claim 7, further comprising steps of:
causing a Web browser to be installed on each of said terminals; and
causing said procedure processing program to be downloaded from said Web server to each of said terminal and executed on said Web browser.

12. The calculation service providing method as set forth in claim 9, further comprising steps of:
causing a Web browser to be installed on each of said terminal; and
causing said procedure data creation program to be downloaded from said Web server to each of said terminal and executed on said Web browser.
